(19) United States
(12) Patent Application Publication
(10) Pub. No.: US 2005/0071874 A1
(43) Pub. Date: Mar. 31, 2005

(54) System and method for an interactive electronic program guide

(76) Inventors: Albert Elcock, Havertown, PA (US); Andrea Harriman, Yardley, PA (US)

Correspondence Address: Caroline Coker;Motorola, Inc. - Law Department, 101 Tournament Drive, Horsham, PA, 19044, US

(21) Appl. No.: 10/634,360

(22) Filed: Aug. 5, 2003

(51) Int. Cl. G06F 3/00; H04N 5/445; G06F 13/00

(52) U.S. Cl. 725/53; 725/52; 725/37; 725/39

(57) ABSTRACT

A system and method for digital video featuring an interactive electronic program guide (“EPG”) is disclosed. The present invention permits an end user to request a program, and using the EPG notify the end user whether the program is scheduled for broadcast in the near future, where missed requests are continually queried. The present invention also selectively adds program(s) requested into the EPG for broadcast based upon the quantity of requests for the program.

### FIELD OF THE INVENTION

The present invention relates to interactive digital data systems. More specifically, the present invention relates to a system and method for digital video featuring an interactive electronic program guide.

### BACKGROUND OF THE INVENTION

In today's large digital video data networks, such as digital cable television, the majority of end users' (consumers) program viewing options (non-special event-type programming) are constrained to conventional fixed schedule program content availability manifested in an end user manually searchable program guide. Despite the high demand by end users for increased functionality, most data networks lack the bandwidth and accompanying resources to provide access to the majority of their programming in a more flexible format.

The conventional approach is not desirable as it places end users with only two (2) drastically different options. An end user may either (1) manually locate the program in an electronic program guide (“EPG”), if available, and tune the desired program content, which is a limited subset of all available program content due to system bandwidth and required resources needed; or (2) not receive the desired content. Given the above two (2) options, there currently exists no intermediate option for end users in the conventional digital video date network.

What is needed is a system and method to provide end users with an intermediate option for requesting desired program content and providing feedback for such requests to the network, such that the network becomes adaptive to end user requests.

(An EPG contains electronic program data (“EPD”), where each EPD pertains to a program and features the program's broadcast date(s) and time(s) broadcasted, or “on-demand” status (if available), in the digital video data network. The EPD data may also include ancillary data such as actors in the program, production company, and genre of program.)

### SUMMARY OF THE INVENTION

An object of the present invention is to provide a system and method for digital video featuring an interactive electronic program guide (“EPG”). It is a further object of the present invention to permit an end user to request a program, and using the EPG, and related data, notify the end user whether the program is scheduled for broadcast in the near future or is currently available. It is a further object of the present invention to selectively add a program requested into the EPG, or related data, for broadcast, or as an addition to the on-demand offerings, if the cumulative number of requests for the program exceeds a pre-defined quantity of requests over a pre-defined period of time. In addition, these requests can be monitored to launch business evaluations on content.

In order to achieve these objectives, as well as others which will become apparent in the disclosure below, the present invention provides a data network for the delivery of digital video featuring an interactive EPG. The data network comprises a head end and a plurality of end user devices communicating over a network.

In a first exemplary embodiment, each end user device receives an EPG on a predefined interval from the head end, and stores the EPG locally within the end user device. Upon user input of a requested program an end user device queries the EPG and returns whether the requested program is in the EPG or not. If in the EPG, the end user device provides the next broadcast date and time, so the end user may view or take any requisite steps to record the program at the next broadcast date and time. If the requested program does not appear in the EPG, the end user is notified of such, and the request is placed in a miss request queue locally in the end user device. The end user device will automatically check the EPG for miss requests in its queue upon receiving EPG updates from the head end

In a second exemplary embodiment, in addition to the process of the first exemplary embodiment, upon a miss request the end user device sends the request to the head end for further query and possible scheduling, based upon cumulative end user demand.

The head end queries an extended database contained therein, which preferably contains more program data than the EPG, for example, two (2) more weeks of scheduling information than the EPG, and reports back to the end user device whether such request will be available, and, if so, the broadcast time and date, and any special format, e.g., pay-per-view, on-demand, etc. The head end also examines both previously scheduled and non-schedule requests for “trip limits” to determine, based upon cumulative end user demand, whether to add a request to the extended database (in the case of a non-scheduled request), or to add more broadcast times, channels, or special formats to a request already scheduled at least once.

In this way, an end user does not have to continually manually search for programs desired, as this is performed automatically after the end user's initial request. Moreover, if many end users have the same miss request, or limited scheduled request, the miss request may be dynamically added to the EPG for an near future broadcast, and more scheduled offering may be provided for the limited scheduled request. Thus, the present system and method provide an adaptive interactive EPG.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is a functional diagram of an exemplary system of the present invention;

FIG. 2(a) is a detailed functional diagram of the head end, an external interactive server, and electronic program guide in accordance with an exemplary embodiment of the present invention;

FIG. 2(b) is an exemplary embodiment of a record of a first data set of the frequency request queue in accordance with the present invention;

FIG. 2(c) is an exemplary embodiment of a record of a second data set of the frequency request queue in accordance with the present invention;

FIG. 3 is a detailed functional diagram of an end user device in accordance with an exemplary embodiment of the present invention;

FIG. 4 is a flow diagram showing the basic process flow of a program request in accordance with a first exemplary embodiment of the present invention; and

FIG. 5(a) is a flow diagram showing the basic process flow of a program request in accordance with a second exemplary embodiment of the present invention;

FIG. 5(b) is a flow diagram showing the process flow when the electronic program guide is updated in an end user device in accordance with an exemplary embodiment of the present invention; and

FIG. 5(c) is a flow diagram showing the process flow when the extended database is updated in the head end in accordance with an exemplary embodiment of the present invention.

### DESCRIPTION OF A PRESENTLY PREFERRED EMBODIMENT

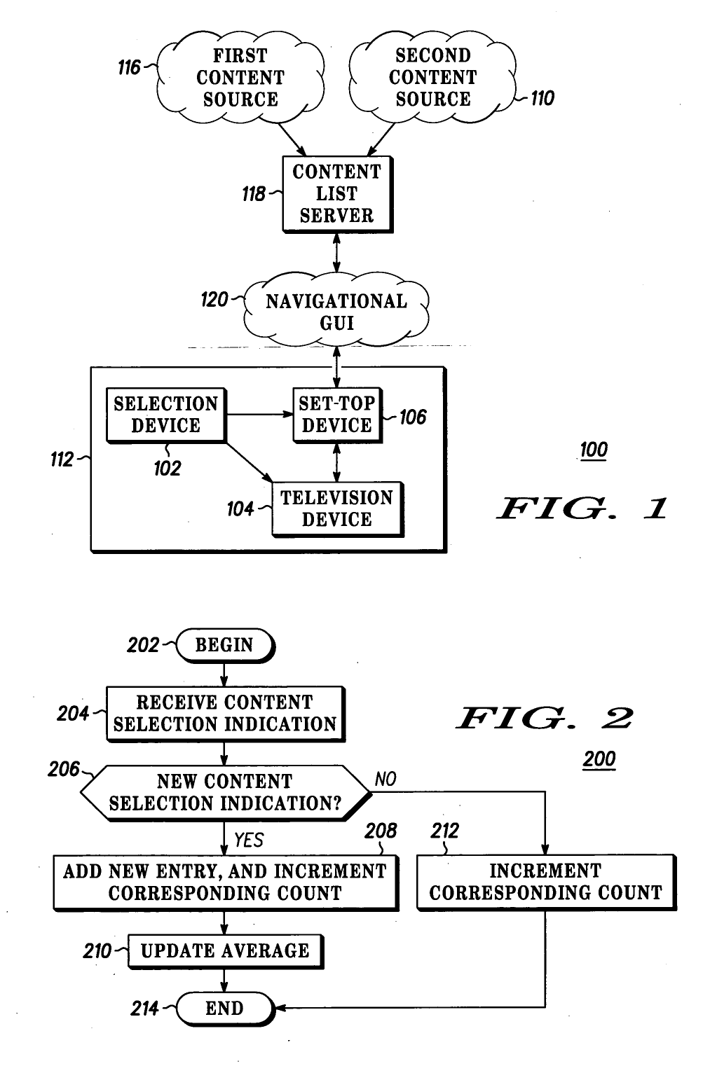

Referring to FIG. 1, in an exemplary embodiment, the present system 100 includes head end 102, and a plurality of end user devices 106, 108. The end user devices 106, 108, may be any device capable of sending and receiving digital data. The end user devices 106, 108 may include digital cable set top boxes, cable modems, digital television tuners, etc. Preferably, end user devices 106, 108 are set top boxes (“STB”). Reference made below to STBs is solely for illustrative purposes, and is inclusive of all end user devices 106, 108 as described above.

The head end 102 and STBs 106, 108 transmit and receive data over a common network 104. The network 104 may be any conventional network commonly known to one skilled in the art, including, but not limited to Ethernet and Gigabit Ethernet (“GigE”). Preferably, network 104 is GigE and operates under the Transmission Control Protocol/Internet Protocol (“TCP/IP”). STBs 106, 108 may be coupled to a variety of external peripherals used to display and send data. Such external peripherals may include televisions 110, monitors 112, personal computers 114, personal web servers 118, Internet appliances 120, and audio devices 122, respectively, as illustrative in FIG. 1.

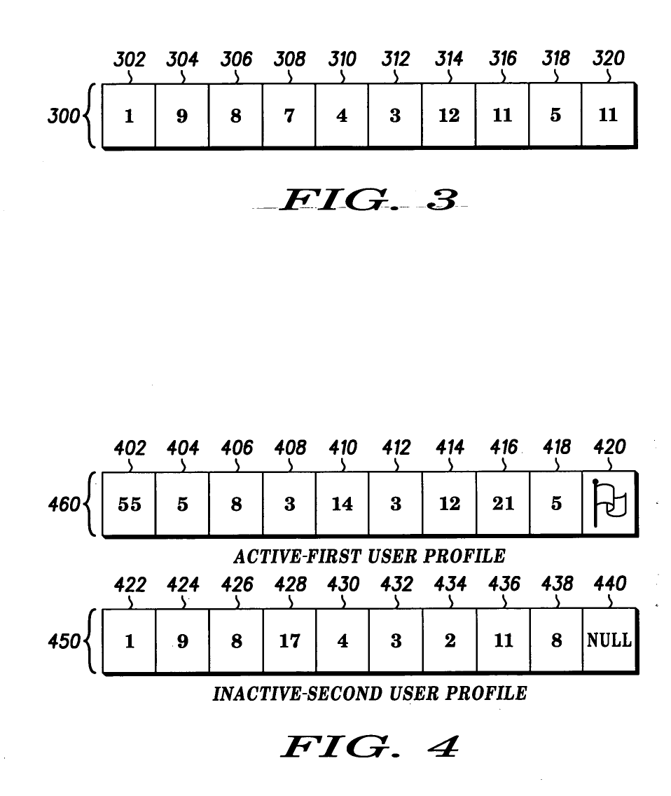

Referring to FIG. 2, in an exemplary embodiment the head end 102 includes an interactive server 204. The interactive server 204 may preferably contain a frequency request queue (“FRE”) processor 210, and EPG storage device 212, and extended database (“EDB”) storage device 214. Further, interactive server 204 may be the initial source of the EPG or may receive the EPG from an external EPG database 208. Alternatively, the interactive server 204 may be located external to head end 102.

EDB includes the EPG plus additional data. For example, preferably the EDB includes at least two (2) weeks more scheduling data than the EPG and also includes a list of all available programs (the library of programming) for system 100. The FRQ processor 210 processes, queries, and updates the FRQ. The FRQ is preferably stored in a relational database with exemplary records such as those illustrated in FIG. 2(b) and 2(c). FIG. 2(b) illustrates a record of a first data set of the FRQ in accordance with this exemplary embodiment of the present invention. The record includes a field for the request, status of the request, e.g., “scheduled” or “not schedule”, and the address of the STB 106, 108 which made the request. A related record of a second data set of the FRQ in accordance with this exemplary embodiment of the present invention is illustrated in FIG. 2(c). The record includes a field for request and cumulative number of requests (“COUNT”) amongst all STBs 106, 108. As not to populate the FRQ with stale data, the FRQ may be refresh by the FRQ processor 210 by clearing all records with “available” in the status field on a pre-defined interval, e.g., once a month, or pre-defined event such as an updated EDB, for example.

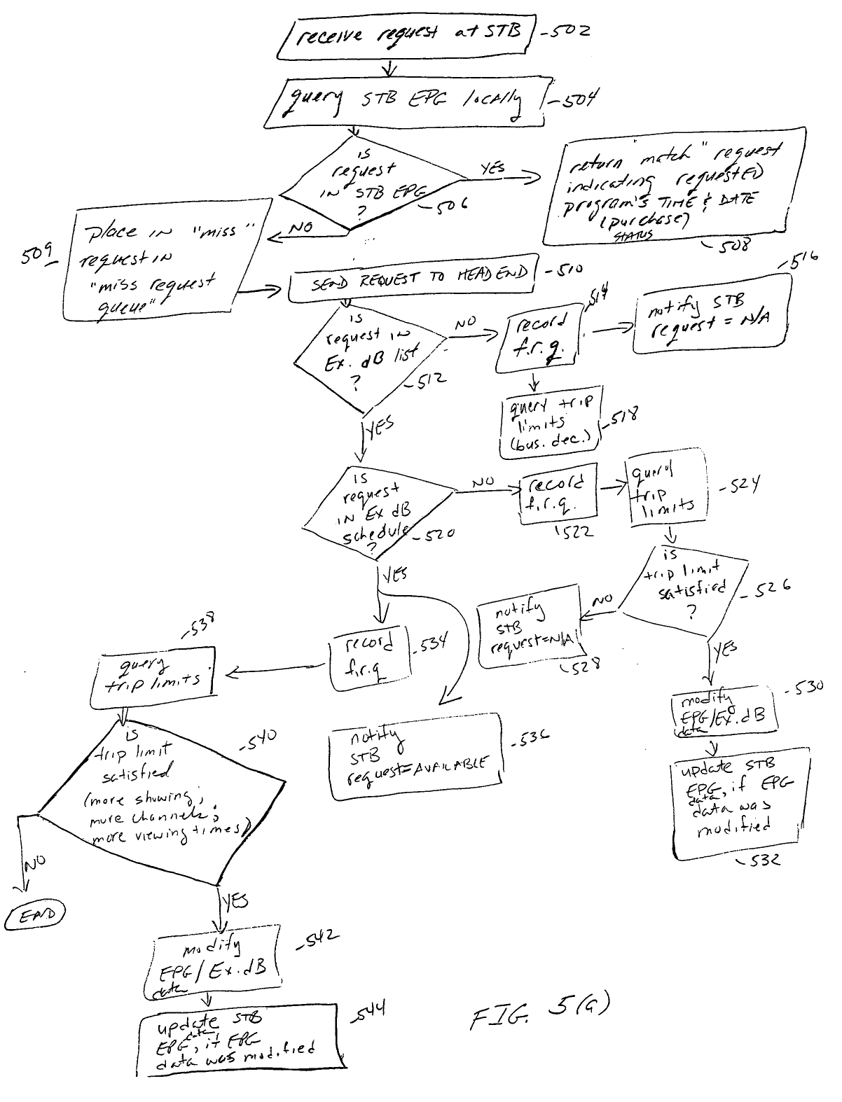

Referring to FIG. 3, in an exemplary embodiment of the present invention a STB 106, 108 includes a central processor 306, for processing incoming and outgoing data in the form of commands and digital data content. The processor 306 is coupled to a tuner 302, which aids in the extraction of a desired program from an incoming bit stream of multiple digital program data. User input (data entry) interface/port 304 is coupled to processor 306 to allow for connectivity of commonly known input device such as keyboards; radio frequency and infrared receivers to receive a signal from wireless remote controls; universal serial bus ports/devices. STB 106, 108 also includes a data port, for connectivity of data input and output devices including high definition television, universal serial bus devices, firewire devices, Ethernet devices, GigE devices, coaxial cable devices, and optical devices, for example.

One or more storage devices 308, 310 are also coupled to processor 306. The storage devices 308, 310 are used to store the EPG, and a queue of requested programs not matched in the EPG (“miss request queue”), as will also be discussed in detail below. Storage devices 308, 310 may include, for example, hard drives, magneto-optical drives, random access memory, flash memory, EEPROM, or any other memory device known to one skilled in the art.

In operation, in accordance with a first exemplary embodiment, each STB 106, 108 preferably receives the EPG on a predefined interval from the head end 102, and stores the EPG locally within the STB's 106, 108 first storage device 308.

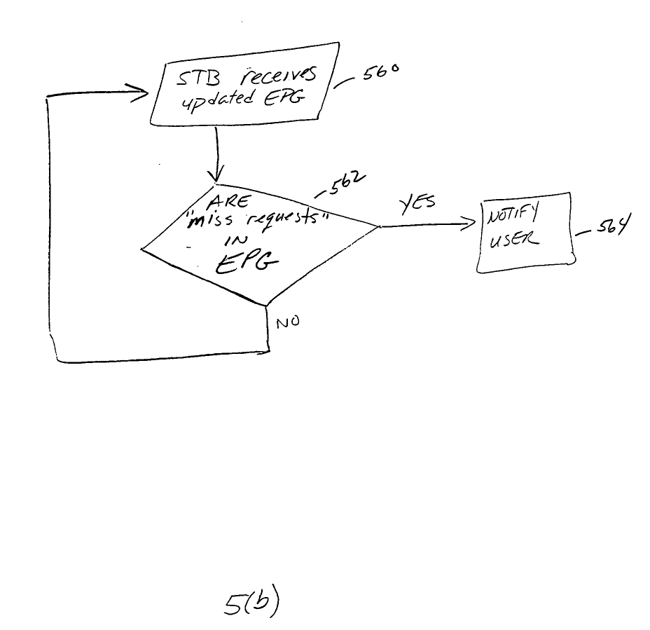

Referring to FIG. 4, upon an end user providing input of a requested program at a STB 106, 108, the end user's STB 106, 108 receives the request, in step 402. The STB 106, 108 then queries the EPG in storage device 308 for the request, in step 404, and returns an indication of whether the requested program is in the EPG or not, in step 406. If the requested program is in the EPG, a “match request,” the STB 106, 108 provides the next broadcast date and time preferably in a display format, so that the end user may view or take any requisite steps to record the program at the next broadcast date and time, in step 408. Further, if the requested program requires an additional fee, e.g., pay-per-view, the STB 106, 108 may provide a method of billing or payment for end user authorization to view the requested program. If the requested program does not appear in the EPG, a “miss request,” the STB 106, 108 notifies the end user of such preferably in a display format, in step 410. Next, the miss request is placed in a miss request queue locally in storage device 310 in the STB 106, 108. Next, the STB 106, 108 preferably waits a pre-defined time, e.g., 72 hours, or until the next EPG update to STB 106, 108, in step 412. Once the wait period of step 412 has been exhausted, or the STB 106, 108 receives an updated EPD, STB 106, 108 automatically checks the EPG for miss requests still residing in its storage device 308. Upon a match, the STB 106, 108 displays a notification to the end user indicating the date and time of broadcast of the miss request and the miss request is removed from storage device 310.

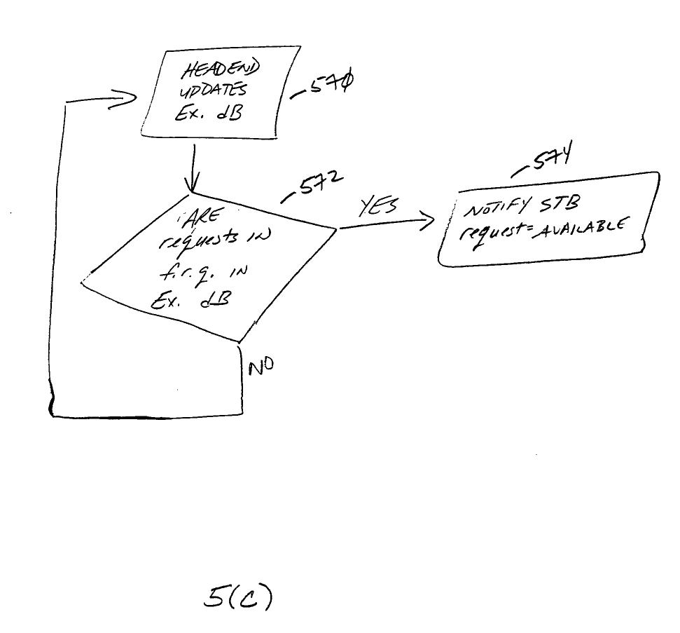

In accordance with a second exemplary embodiment, referring to FIG. 5(a), upon an end user providing input of a requested program at a STB 106, 108, the end user's STB 106, 108 receives the request, in step 502. The STB 106, 108 then queries the EPG in storage device 308 for the request, in step 504, and returns an indication of whether the requested program is in the EPG or not, in step 506. If the requested program is in the EPG, a “match request,” the STB 106, 108 provides the next broadcast date and time preferably in a display format, so that the end user may view or take any requisite steps to record the program at the next broadcast date and time, in step 508. Further, if the requested program requires an additional fee, e.g., pay-per-view, the STB 106, 108 may provide a method of billing or payment for end user authorization to view the requested program. If the requested program does not appear in the EPG, a “miss request,” the STB 106, 108 places the “miss request” in a queue locally in storage device 310 in the STB 106, 108, in step 509. Next, the STB 106, 108, sends the request to the head end 102, in step 510. The FRQ processor 204 of interactive server 204 in the head end 102 then checks whether the request is in the EDB list of programs available in the system 100 (“EDB list”), in step 512. If the request is not the EDB list, the request is recorded in the FRQ, in step 514. The STB 106, 108 is then notified that the request is not available, in step 516. At this point, since the EDB has the full exhaustive list of programs available, it may aid the end user via interaction with STB 106, 108 if it determines that the request may be an incorrect spelling of a request in the EDB list. Presuming the request was not misspelled, in step 518, the request is placed in a business decisions queue, to inform the operators of system 100 of requests which are not in the EDB list, which the operators of system 100 may decide to purchase from third parties and subsequently schedule.

If the request is in the EDB list, FRQ processor 210 then checks the EDB schedule of program broadcast dates and time (“EDB schedule”) to determine whether the request is in the EDB schedule, in step 520. If the request is not in the EDB schedule, the request is recorded in the FRQ, in step 522. The FRQ processor 210 then checks the FRQ for trip limits, in step 524. Trip limits are numerical pre-defined values, which may trigger the scheduling of a request. For example, if a request is not in the EDB schedule, if X amount of request are received the request may be scheduled once in the near future. If Y amount of requests are received, where Y is greater than X, the request may be scheduled for more than one channel or more than one broadcast date and time. If Z amount of requests are received, where Z is greater than Y, the request may be scheduled on pay-per-view or on-demand (depending on the bandwidth of system 100). If no trip limits are satisfied, the STB is notified that the request is not available, in step 528. The STB 106, 108, in turn, preferably notifies the end user via display. If a trip limit is satisfied, the request is scheduled and the EPG and/or EDB schedule are updated, in step 530, and the processes of FIG. 5(b) and 5(c) are executed, as described below. (If the EPG is updated, STB 106, 108 receives the EPG update, in step 532.)

If the request is in the EDB schedule, the FRQ processor 210 notifies the STB 106, 108 of the availability of the request, in step 536. The STB 106, 108, in turn, notifies the user via display, as described above, and removes the request from the “miss request queue” in the STB 106, 108. The FRQ processor 210 simultaneously records the request in the FRQ, in step 534. Even though the request is available, this step is performed to allow the head end 102 to test trip limits in step 538, allowing the head end 102 to add additional channels and/or broadcast date and times if trip limits are satisfied. If no trip limits are satisfied, no additional broadcast dates, times or channels are added. As described above, if a trip limit is satisfied, the request is scheduled and the EPG and/or EDB schedule are updated, in step 542, and the processes of FIG. 5(d) and 5(e) are executed, as described below. (If the EPG is updated, STB 106, 108 receives the EPG update, in step 544.)

Referring to FIG. 5(b), upon an update of the local EPG in STB 106, 108, in step 560, the updated EPG is searched for miss requests in storage device 310, step 562. If a miss request is in the updated EPG, the STB 106, 108 displays a notification to the end user indicating the date and time of broadcast of the miss request, in step 564. Further, if the miss request is not in the updated EPG, the STB 106, 108 awaits its next EPG update.

Referring to FIG. 5(c), upon an update to the EDB list or EDB schedule, in step 570, FRQ processor 210 checks for requests in the FRQ that are now in the updated EDB schedule and notifies the STBs 106, 108 that new or additional broadcasts dates, time, channels, and premium formats, e.g., per-per-view, on-demand, etc., are available. Further, if the request is in the FRQ and is not in the updated EDB schedule, the FRQ processor 210 awaits its next EPG update.

Thus, using the present system and method an end user (1) does not have to continually manually search for programs desired, as this is performed automatically after the end user's initial request. Moreover, if many end users have the same miss request, or limited scheduled request, the miss request may be dynamically added to the EPG for an near future broadcast, and more scheduled offering may be provided for the limited scheduled request. Thus, the present system and method provides an adaptive interactive EPG.

The above system and method may be implemented by many computer languages commonly known in the art and may operate on many computer platforms which include both volatile and non-volatile memory storage devices. In a preferred embodiment, the system and method of the present invention is implemented, in whole or in part, on a cable network systems. Software code encapsulating the functionality of the present inventive technique may be implemented on such computer systems, preferably written in C++.

Although the invention has been described herein by reference to an exemplary embodiment thereof, it will be understood that such embodiment is susceptible of modification and variation without departing from the inventive concepts disclosed. All such modifications and variations, therefore, are intended to be encompassed within the spirit and scope of the appended claims.

1. An end user device for receiving an electronic program guide from a head end, said end user device comprising:
data entry interface for receiving an input of a program request;
memory for receiving said electronic program guide from said head end; and
search means for searching said electronic program guide for said program request, wherein if said program request is not in said memory, said search means sends said program request to said head end.

2. The end user device of claim 1, wherein said data entry interface comprises at least one of a radio frequency receiver to receive a signal from a wireless remote control, an infrared receiver to receive a signal from a wireless remote control, an universal serial bus interface, or keyboard interface.

3. The end user device of claim 1 further comprising a data port.

4. The end user device of claim 3, wherein said data port comprises at least one of a universal serial bus interface, a firewire interface, an Ethernet interface, a coaxial cable interface, or an optical interface.

5. A head end for receiving a program request from an end user device, said head end comprising:
a first memory for storing an electronic program guide, said electronic program guide being sent from said first memory to said end user device; and
a second memory for receiving a program request from said end user device.

6. The head end of claim 5 further comprising an interactive server, said interactive server receiving said program request not in said electronic program guide from said end user device, said interactive server selectively adding said program request to one of said electronic program guide or extended database schedule in response to the quantity of cumulative requests for said program request not is said electronic program guide.

7. The head end of claim 5 further comprising an interface for communicating with an external interactive server, said external interactive server receiving said program request not in said electronic program guide from said head end, and selectively adding said program request to one of said electronic program guide or extended database schedule in said head end in response to the quantity of cumulative requests for said program request not is said electronic program guide.

8. A system for an interactive electronic program guide, said system comprising:
an end user device, said end user device receiving a program request to query an electronic program guide; and
a head end coupled to said end user device, said head end supplying an electronic program guide to said end user device, said end user device searching said electronic program guide for said program request, wherein if said program request is not in said electronic program guide said end user sends said program request to said head end.

9. The system of claim 8, wherein said end user device comprises:
a processor, said processor managing interaction with said electronic program guide;
a tuner coupled to said processor, said tuner receiving said program in said request; and
one or more storage devices coupled to said processor, said one or more storage devices storing an electronic program guide and a list of a plurality of said program requests not in said electronic program guide.

10. The system of claim 9 further comprising an input port coupled to said processor.

11. The system of claim 10, wherein said input port comprises at least one of a radio frequency receiver to receive a signal from a wireless remote control, an infrared receiver to receive a signal from a wireless remote control, an universal serial bus interface, or keyboard interface.

12. The system of claim 9, wherein said end user device further comprises a data port.

13. The system of claim 12, wherein said data port comprises at least one of a universal serial bus interface, a firewire interface, an Ethernet interface, a coaxial cable interface, or an optical interface.

14. The system of claim 8, wherein said head end comprises an interactive server, said interactive server receiving said program request not in said electronic program guide from said end user device, said interactive server selectively adding said program request to one of said electronic program guide or extended database schedule in response to the quantity of cumulative requests for said program request not is said electronic program guide.

15. The system of claim 8 further comprising an external interactive server, said external interactive server receiving said program request not in said electronic program guide from said head end, and selectively adding said program request to one of said electronic program guide or extended database schedule in said head end in response to the quantity of cumulative requests for said program request not is said electronic program guide.

16. The system of claim 8 further comprising a monitor display coupled to said end user device.

17. The system of claim 8 further comprising a television display coupled to said end user device.

18. The system of claim 8 further comprising a personal computer coupled to said end user device.

19. The system of claim 8 further comprising an audio output device coupled to said end user device.

20. A method for providing an interactive electronic program guide, said method comprising:
receiving a program request;
querying an electronic program guide for said request;
supplying a result of said request, wherein said result provides a matched indication, said matched indication providing a next broadcast time period in said electronic program guide for said request; or a miss indication, said miss indication providing data indicating that said request was not found in said electronic program guide; and
selectively adding said request of said miss indication to at least one of said electronic program guide or extended database in response to a quantity of said miss indications for said request.

21. The method of claim 20 further comprising the step of receiving said request from at least one of a wireless remote control, a universal serial bus port interface, a keyboard, a firewire interface, an Ethernet interface.

22. The method of claim 20 further comprising a step of updating said electronic program guide.

23. The method of claim 20 further comprising a step of updating said extended database.

24. The method of claim 20 further comprising a step of receiving said electronic program guide.
